(19) United States
(12) Patent Application Publication
(10) Pub. No.: US 2021/0402443 A1
(43) Pub. Date: Dec. 30, 2021

(54) DEVICE FOR CLEANING AND POLISHING CONNECTIONS OF UNDERWATER EQUIPMENT

(71) Applicant: PETRÓLEO BRASILEIRO S.A. - PETROBRAS, Rio de Janeiro (BR)

(72) Inventor: Carlos Américo VEIGA DAMASCENO JÚNIOR, Macaé (BR)

(21) Appl. No.: 17/052,516

(22) PCT Filed: Apr. 29, 2019
(86) PCT No.: PCT/BR2019/050157

§ 371 Date: Nov. 2, 2020

(30) Foreign Application Priority Data
May 3, 2018 (BR) 10 2018 008935 8

(51) Int. Cl. B08B 1/04; B08B 1/00; A46B 13/00; A46B 13/02; A46B 11/06; B24B 57/02; B63C 11/52

(52) U.S. Cl. CPC B08B 1/04; B08B 1/002; A46B 13/008; A46B 13/001; A46B 2200/3086; A46B 11/063; B24B 57/02; B63C 11/52; A46B 2200/3073; A46B 13/02

(57) ABSTRACT

The present disclosure relates to a device for cleaning and polishing connections of underwater equipment, comprising a connecting element designed to be connected to a torque generating device; a cleaning fluid discharging device comprising at least one tank of cleaning fluid; and a cleaning element connected to the discharging device via a support for the cleaning element, wherein the support for the cleaning element comprises at least one channel that connects the at least one tank of cleaning fluid to the cleaning element, wherein the cleaning fluid discharging device comprises a piston, which, in its turn, comprises: at least one tank of cleaning fluid; and at least one actuating chamber, wherein at least the actuating chamber comprises a pressure compensating system.

### CROSS-REFERENCE TO RELATED APPLICATIONS

This application is a United States National Stage Application of co-pending International Patent Application Number PCT/BR2019/050157 filed 29 Apr. 2019, which claims the benefit of priority to BR 10 2018 008935 8, filed 3 May 2018, the contents of which is are incorporated herein by reference in their entireties.

### TECHNICAL FIELD

The present disclosure relates to tools for cleaning and polishing connections of underwater equipment. More specifically, the present disclosure relates to tools for cleaning and polishing connections of underwater equipment with electrohydraulic umbilicals.

### BACKGROUND

The prior art offers a number of tools for cleaning and polishing connections of underwater equipment. However, the existing cleaning devices that are used, known as rotary bristle brushes, are inefficient, time-consuming and demand considerable resources, resulting in high operating costs, especially when operated at great depths, where their operation is affected by the pressure of the water column.

Some examples of tools of this type known from the prior art will be described hereunder.

Document U.S. Pat. No. 7,543,354 B2 relates to a rotating brush head for cleaning surfaces, in which a through passage for cleaning fluid is defined in the shaft for rotation of the brush head.

U.S. Pat. No. 7,543,354 B2 relates to cleaning the surface of closed vessels, it being proposed that a cleaning fluid is injected externally in the vessel and is collected by the through passage for liquid. The inlet of the return of the through passage is positioned in the central region of a lower cleaning element.

The cleaning fluid is stored in a tank just above the cleaning brush and drained by lateral channels to the vessel to be cleaned, into which the fluid is drawn via the through passage.

Thus, document U.S. Pat. No. 7,543,354 B2 discloses a rotating brush for cleaning surfaces that comprises a central channel for circulation of a cleaning fluid and a cleaning fluid storage tank positioned above the cleaning element of the brush.

However document U.S. Pat. No. 7,543,354 B2 makes no reference to controlling the pressure of the cleaning fluid so that the latter is injected evenly during the cleaning process.

Document U.S. Pat. No. 3,943,591 A relates to a rotating cleaning brush that comprises a rotating cleaning element, in the form of a brush, a tank of cleaning fluid, and a central channel for releasing cleaning fluid, in which the channel extends through the inside of the shaft for rotation of the cleaning element.

According to the configuration described in document U.S. Pat. No. 3,943,591 (A), the cleaning fluid is pumped through a central channel by means of an electric pump.

Thus, document U.S. Pat. No. 3,943,591 A discloses a rotating brush for cleaning surfaces that comprises a cleaning element in the form of a rotating brush and injection of a cleaning fluid in the central region of the rotating brush, wherein the cleaning fluid is stored in a tank positioned in the upper region of the cleaning element.

However, document U.S. Pat. No. 3,943,591 A does not make any reference to controlling the pressure of the cleaning fluid so that the latter is injected evenly during the cleaning process.

Document U.S. Pat. No. 8,047,736 B2 relates to a floor washer that comprises a rotating brush, and a cleaning fluid dispenser mounted in the brush assembly, the cleaning fluid being stored in a tank.

U.S. Pat. No. 8,047,736 B2 further describes that the brush (cleaning element) is connected to the main element by means of screws, so that both elements comprise a channel for the passage of cleaning fluid.

Thus, U.S. Pat. No. 8,047,736 B2 discloses a configuration in which the device is divided into two parts, a cleaning element and a main element that comprises, among other elements, a tank of cleaning fluid.

Accordingly, U.S. Pat. No. 8,047,736 B2 discloses a rotating brush for cleaning surfaces that comprises a cleaning element in the form of a rotating brush and injection of a cleaning fluid in the central region of the rotating brush, wherein the cleaning fluid is stored in a tank positioned in the upper region of the cleaning element. In addition, this document discloses that the cleaning element is connected to the main element of the device by means of screws.

However, document U.S. Pat. No. 8,047,736 B2 does not make any reference to controlling the pressure of the cleaning fluid so that the latter is injected evenly during the cleaning process, which would allow it to be used in underwater applications at great depths.

### SUMMARY

As will be described in more detail below, the present disclosure aims to solve the problems of the prior art described above in a practical and efficient manner.

The present disclosure aims to provide a device for cleaning and polishing connections of underwater equipment with electrohydraulic umbilicals, which comprises a mechanism for distributing cleaning fluid that ensures constant distribution of fluid even when used at great depths under water.

In order to achieve the aims described above, the present disclosure provides a device for cleaning and polishing connections of underwater equipment, comprising a connecting element designed to be connected to a torque generating device; a device for discharging cleaning fluid comprising at least one tank of cleaning fluid; and a cleaning element connected to the discharging device via a support to the cleaning element, wherein the support for the cleaning element comprises at least one channel that connects the at least one tank of cleaning fluid to the cleaning element, wherein the device for discharging cleaning fluid comprises a piston, in its turn comprising: at least one tank of cleaning fluid; and at least one actuating chamber, wherein at least the actuating chamber comprises a pressure compensating system.

### BRIEF DESCRIPTION OF THE FIGURES

The detailed description presented hereunder refers to the appended figures and their respective reference numbers.

FIG. 1a illustrates an optional configuration of the device for cleaning and polishing connections of underwater equipment of the present disclosure, wherein the cleaning element is of the disk type.

FIG. 1b illustrates an optional configuration of the device for cleaning and polishing connections of underwater equipment of the present disclosure, wherein the cleaning element is of the cylinder type.

FIG. 2a illustrates a cross-sectional view of an optional configuration of a support for the cleaning element relative to the configuration illustrated in FIG. 1a.

FIG. 2b illustrates a cross-sectional view of a configuration of a support for the cleaning element relative to the configuration illustrated in FIG. 1b.

FIG. 3a is a graphical illustration of a situation in which the pressure exerted in a device for discharging fluid, as known in the prior art, is not sufficient to provide discharge of the cleaning fluid.

FIG. 3b illustrates a device for discharging cleaning fluid provided with a pressure compensating system, in a situation in which the fluid is not discharged.

FIG. 3c illustrates a device for discharging cleaning fluid provided with a pressure compensating system, in a situation in which the fluid is discharged.

FIG. 4 shows a view of the upper portion of an actuating chamber according to an optional configuration of the present disclosure.

FIG. 5 illustrates an alternative configuration of the pressure compensating system of the present disclosure, wherein an equalizing channel is provided in the actuating chamber.

### DETAILED DESCRIPTION

Firstly, it is emphasized that the description given hereunder will be based on a preferred embodiment of the invention. As will be obvious to a person skilled in the art, however, the invention is not limited to this particular embodiment.

The present disclosure relates to a device that serves as a tool for carrying out cleaning and polishing of the connections of underwater equipment to electrohydraulic umbilicals. As will be clear from the description given hereunder, the proposed solution aims to eliminate, or minimize, the use of the conventional rotating brush with bristles, to increase the efficiency of the cleaning procedure and reduce the operating time.

The existing systems offer low efficiency of removal of scale and oxides. The long operating time consumes resources of the other equipment involved in the operation, such as: the vehicle for remote operation, ship and winch. There is increased risk of accident owing to the greater physical fatigue of the operator caused by the long operating time.

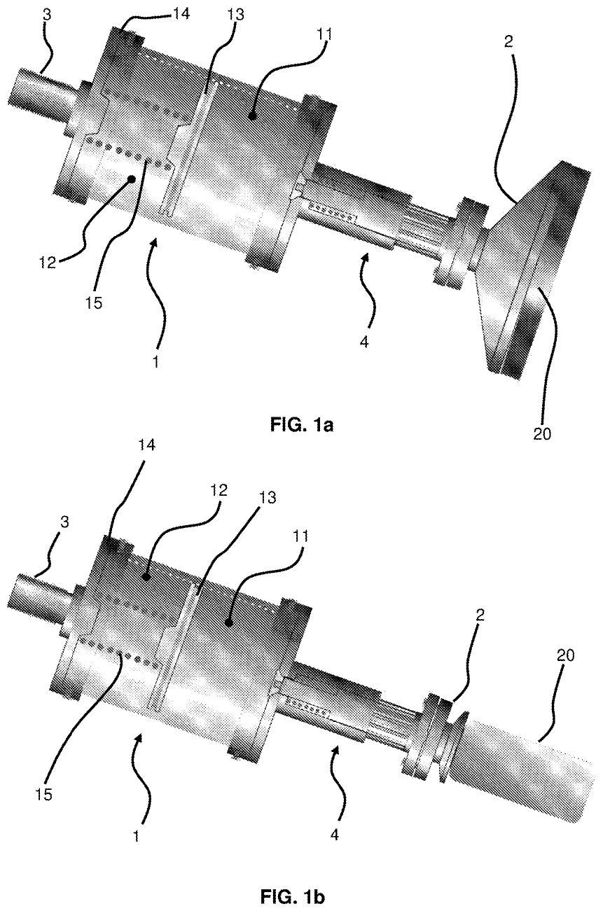

Thus, as illustrated in FIGS. 1a and 1b, the disclosure provides a device for cleaning and polishing connections of underwater equipment, comprising: a connecting element 3 designed to be connected to a torque generating device; a cleaning fluid discharging device 1 comprising at least one tank 11 of cleaning fluid; and a cleaning element 20 connected to the discharging device 1 via a support 2 for the cleaning element 20. In addition, the support 2 for the cleaning element 20 comprises at least one channel 21 that connects the at least one tank 11 of cleaning fluid to the cleaning element 20.

Optionally, as illustrated in the relevant figures, the cleaning device of the present disclosure comprises an extender 4 positioned between the cleaning element 20 and the cleaning fluid discharging device 1. It is emphasized that even though all the configurations illustrated in the present specification comprise the use of this extender 4, this element is optional, so that the support 2 for the cleaning element 20 may be fixed directly on the cleaning fluid discharging device 1.

In the configurations in which the extender 4 is adopted, this element may also comprise a channel 21 that connects the at least one tank 11 of cleaning fluid to the cleaning element 20 (fixed to the support 2 for the cleaning element 20).

So as to permit better operation of the tool, even when subjected to high pressures, as is the case in underwater operations, the cleaning fluid discharging device 1 comprises a piston 13, which comprises: at least one tank 11 of cleaning fluid; and at least one actuating chamber 12, wherein the at least one actuating chamber 12 comprises a pressure compensating system.

As described, the connecting element 3 is designed to be connected to a torque generating device, in order to rotate the whole device, preferably at high rotary speed, providing cleaning of the desired surface by the cleaning element 20. The connection between the connecting element 3 and the torque generating device may be made by means of a screw thread, screws, or any other fastening means. If fastening is by means of a screw thread, a screw thread may be adopted that is opposite to the rotation, in the upper part of the connecting element 3.

In addition, it can be seen that FIGS. 1a and 1b illustrate optional configurations of the disclosure that are slightly different from one another, but their essential elements are the same. The cleaning element 20 in FIG. 1a is of the disk type, allowing it to be used for cleaning and polishing flat surfaces. The cleaning element 20 in FIG. 1b is of the cylinder type, allowing it to be used for cleaning and polishing concave surfaces, for example. Similarly, the supports 2 for the cleaning elements of both configurations vary depending on the shape of the cleaning element 20.

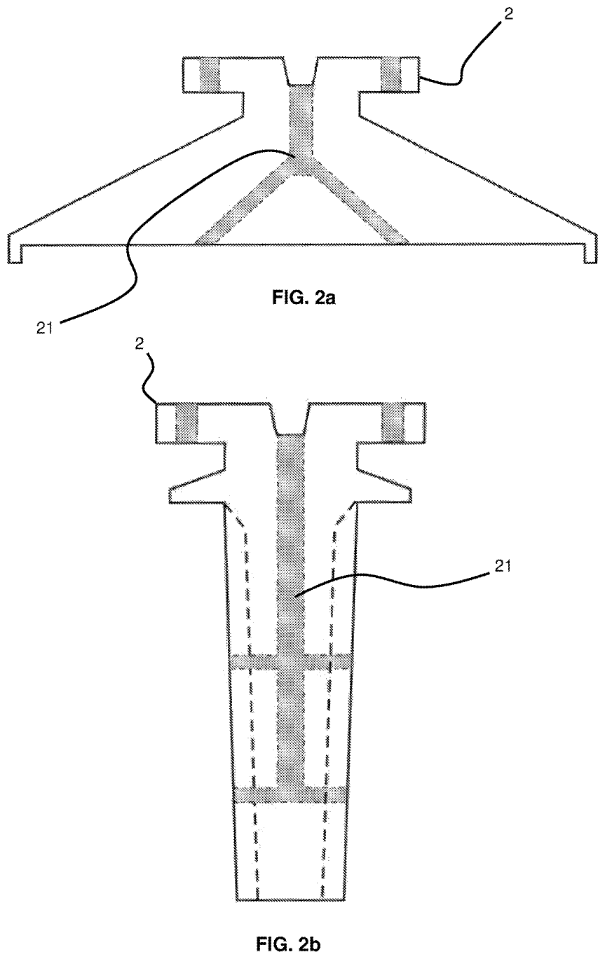

FIGS. 2a and 2b illustrate cross-sectional views of configurations of support 2 for the cleaning element 20, relative to the configurations illustrated in FIGS. 1a and 1b, respectively. It can be seen more clearly from these figures that the support for the cleaning element 20 comprises at least one channel 21 that connects the at least one tank 11 of cleaning fluid to the cleaning element 20. Thus, fluid from tank 11 is directed to the cleaning element 20, which aids removal of dirt and scale, for example.

Optionally, the at least one channel 21 of the support 2 for the cleaning element 20 is branched so as to discharge fluid at different points of the cleaning element 20, which provides more uniform cleaning.

Regarding the cleaning fluid discharging device 1, it is to be understood that the actuating chamber 12 comprises means for actuating the piston 13, exerting pressure on the cleaning fluid contained in the tank 11 of cleaning fluid so that the latter flows through at least one channel 21 that connects the at least one tank 11 of cleaning fluid to the cleaning element 20. Thus, the cleaning fluid flows through at least one channel 21, and is discharged in the cleaning element 20 through the support 2.

Optionally, an elastic element, such as a spring, is employed in the actuating chamber 12 as a means for actuating the piston 13. Thus, the spring would supply a substantially constant pressure in the liquid, which ensures constant discharge of cleaning fluid.

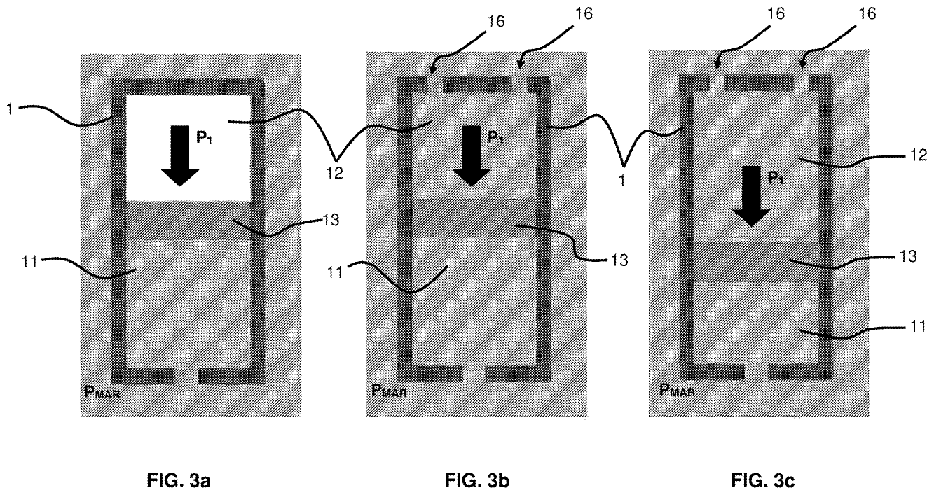

However, in underwater operations at great depths, the external pressure of the water P_{SEA} may be very high. In cases in which the fluid discharging device 1 is a closed vessel, the pressure exerted by the means for actuating the piston 13, in the fluid discharging device 1, may be less than the external pressure, which would make discharge of the cleaning fluid impossible during use. FIG. 3a is a graphical illustration of the situation described, where P_{MAR}=P_{SEA}, and in which the pressure exerted P1 is not sufficient to provide discharge of the cleaning fluid.

In order to permit better operation of the tool, even when subjected to high pressures, the disclosure envisages that at least the actuating chamber 12, of the cleaning fluid discharging device 1, is provided with a pressure compensating system, as illustrated graphically in FIGS. 3b and 3c.

In the configuration illustrated, the actuating chamber 12 comprises openings 16 allowing communication of the interior of the actuating chamber 12 with the surroundings, i.e. allowing entry of seawater, equalizing the internal pressure (in the actuating chamber 12) with the external pressure (P_{MAR} or P_{SEA}). This reduces the pressure that the means for actuating the piston 13 has to exert for the cleaning fluid to be discharged.

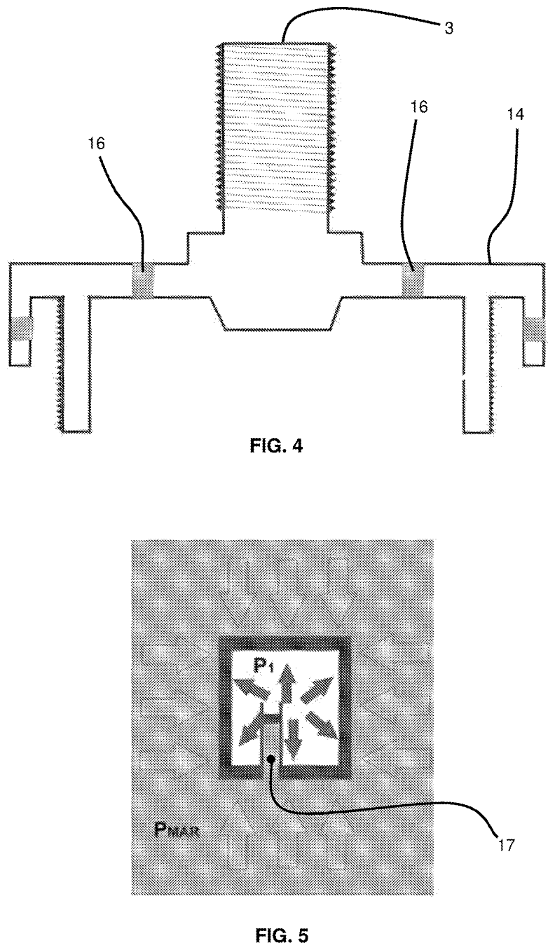

FIG. 4 shows a view of the upper portion 14 of the actuating chamber 12 according to an optional configuration of the present disclosure. In this configuration, the actuating chamber 12 comprises openings 16 that provide communication of the interior of the chamber with the surroundings, allowing the pressures inside and outside to be equalized.

FIG. 5 illustrates yet another possible alternative configuration of the pressure compensating system described, in which an equalizing channel 17 is provided. Although the figure illustrates one configuration of this channel, it is to be understood that it is positioned in the actuating chamber 12, replacing the openings 16 illustrated in FIG. 4.

According to this configuration, the equalizing channel 17 extends to the interior of the actuating chamber 12, so that a moveable stopping element is provided in this channel. Thus, when the device of the present disclosure is used at high external pressure, the stopping element is moved through the channel (towards the interior) until the pressure is equalized. With this optional configuration, entry of water into the actuating chamber 12 is prevented, which may be an advantage if desired.

Optionally, the equalizing channel 17 comprises a limiter of movement of the moveable stopping element to prevent the latter being inserted fully into the actuating chamber 12, which would allow entry of water in the chamber.

Optionally, the pressure compensating system described may be applied in any and every chamber that forms part of the device now described.

Optionally, the cleaning element 20 is of the abrasive synthetic sponge type and has various diameters. However, it has to be understood that other types of cleaning elements may be adopted, made of different materials and with different shapes.

Moreover, the cleaning element 20 may be replaceable, so that, after it has worn out, it can be changed quickly, keeping the other original parts of the device.

As is known by a person skilled in the art, the cleaning fluid employed may be any fluid known in the prior art, for example such as, but not limited to, liquid detergents, abrasive pastes or various chemical reagents for aiding removal of scale and oxides.

In optional configurations, the device for cleaning and polishing connections of underwater equipment of the present disclosure may comprise a device for blocking the discharge of cleaning fluid. This device may be employed to prevent loss of fluid before use. The actuation of this device may be of various forms and will not be discussed here.

In addition, the device for cleaning and polishing connections of underwater equipment now described may also comprise shock-absorber elements to minimize shocks during use of the tool, which would ensure a longer useful life. Similarly, this device will not be discussed in the present application, but it is to be understood that any shock-absorber element may be adopted.

Thus, it will be clear that the invention now described solves in a hitherto unknown manner the problems of the prior art for which it is proposed, i.e. to provide a device for cleaning and polishing connections of underwater equipment with electrohydraulic umbilicals, which comprises a mechanism for distributing cleaning fluid that ensures constant distribution of fluid even when used at great depths under water.

1. Device for cleaning and polishing connections of underwater equipment, comprising:
a connecting element designed to be connected to a torque generating device;
a cleaning fluid discharging device comprising at least one tank of cleaning fluid; and
a cleaning element connected to the discharging device via a support for the cleaning element,
in which the support for the cleaning element comprises at least one channel that connects the at least one tank of cleaning fluid to the cleaning element,
wherein
the cleaning fluid discharging device comprises a piston, which comprises:
at least one tank of cleaning fluid; and
at least one actuating chamber,
in which at least the actuating chamber comprises a pressure compensating system.

2. Device according to claim 1, wherein the connection between the connecting element and the torque generating device is made by one of: screw thread, and screws.

3. Device according to claim 1, wherein the cleaning element is of a disk type.

4. Device according to claim 1, wherein the cleaning element is of a cylinder type.

5. Device according to claim 1, wherein the at least one channel of the support for the cleaning element comprises branchings, these branchings being directed to different points of the cleaning element.

6. Device according to claim 1, wherein the at least one actuating chamber comprises means for actuating the piston.

7. Device according to claim 6, wherein the means for actuating the piston comprises an elastic element.

8. Device according to claim 1, wherein the actuating chamber comprises openings for communication between the interior of the actuating chamber and the surroundings.

9. Device according to claim 1, wherein the actuating chamber comprises an equalizing channel that extends to the interior of the actuating chamber, a moveable stopping element being provided in this channel.

10. Device according to claim 9, wherein the equalizing channel comprises a limiter of movement of the moveable stopping element suitable for preventing the latter being inserted fully in the actuating chamber.

11. Device according to claim 1, further comprising an extender positioned between the cleaning element and the cleaning fluid discharging device.
